(19) United States
(12) Patent Application Publication
(10) Pub. No.: US 2010/0301799 A1
(43) Pub. Date: Dec. 2, 2010

(54) POWER CONTROL CIRCUIT AND BATTERY MODULE INCLUDING THE SAME

(76) Inventors: Chih-Hsiung Lin, TAIPEI CITY (TW); Shyh-Heh Hwang, TAIPEI CITY (TW)

Correspondence Address: NORTH AMERICA INTELLECTUAL PROPERTY CORPORATION, P.O. BOX 506, MERRIFIELD, VA, 22116, US

(21) Appl. No.: 12/790,957

(22) Filed: May 31, 2010

(30) Foreign Application Priority Data
Jun. 1, 2009 (TW) 098118023

(51) Int. Cl. H01M 10/46

(52) U.S. Cl. 320/101; 320/124

(57) ABSTRACT

This invention provides a power control circuit and a battery module including the same. The power control circuit is provided in an electronic device and is connected a solar power supply. The electronic device includes a first battery and a second battery. The power control circuit includes a processing unit and a control unit. When the processing unit is connected to the solar power supply, the processing unit outputs a first control signal. The control unit is connected to the processing unit, the first battery, and the second battery, respectively. Further, the control unit receives the first control signal to control the first battery and the second battery to alternately supply power to the electronic device and to control the first battery and the second battery to be alternately charged by the solar power supply.

### CROSS-REFERENCE TO RELATED APPLICATIONS

This Non-provisional application claims priority under 35 U.S.C. §119(a) on Patent Application No(s). 098118023 filed in Taiwan, Republic of China on Jun. 1, 2009, the entire contents of which are hereby incorporated by reference.

### BACKGROUND OF THE INVENTION

1. Field of the Invention

This invention relates to a power control circuit and a battery module including the same.

2. Description of the Related Art

With development of technology and increase of users' needs, a plurality of electronic devices are designed to be thinner and thinner thus to facilitate carrying by the users. Most of portable electronic devices, such as a notebook computer, a tablet computer, a mobile phone, a personal digital assistant, a multimedia player, a digital camera and so on, can selectively obtain power from batteries or commercial power.

When the portable electronic device obtains the power from the commercial power, an AC-DC adapter is usually needed to adjust voltage and current of the commercial power to be within an acceptable range of the portable electronic device. The AC-DC adapter also provide stable voltage and current for the portable electronic device thus to maintain stability of each component in the portable electronic device.

In addition, a universal serial bus (USB) widely used at present can transmit about 5V power. Therefore, some portable electronic devices with lower power consumption, such as a mobile phone, a multimedia player and so on, can be connected to the commercial power or data processing systems, such as a computer, via USB cables thus to receive the power from the commercial power or the data processing systems.

With improvement of environmental consciousness, natural energy, such as solar energy, is used to generate power thus to prevent energy from being exhausted in a long time and being monopolized.

However, currently, efficiency of converting the solar energy to power energy is still low, and in one day, intensity of the solar energy changes with positions of the sun and weather at any time, which limits an application range of the solar energy. At present, products using the power supplied by the solar energy on a market are mainly the products with lower power, such as a lamp, a watch, a calculator and so on, or the products still using the commercial power or the batteries as the main power source.

### BRIEF SUMMARY OF THE INVENTION

One objective of this invention is to provide a power control circuit. Particularly, the power control circuit in the invention can adjust power configuration modes according to different power sources thus to prolong using time of an electronic device by efficiently using power energy converted from solar energy.

A power control circuit in the invention is provided in an electronic device and is connected to a solar power supply. The electronic device includes a first battery and a second battery. The power control circuit includes a processing unit and a control unit.

When the processing unit is connected to the solar power supply, the processing unit outputs a first control signal. The control unit is connected to the processing unit, the first battery, and the second battery, respectively. The control unit receives the first control signal to control the first battery and the second battery to alternately supply power to the electronic device and to control the first battery and the second battery to be alternately charged by the solar power supply.

Another objective of the invention is to provide a battery module for supplying power to an electronic device.

A battery module in the invention includes a first battery, a second battery, and a power control circuit. The power control circuit is connected to a solar power supply for controlling operation of the first battery and the second battery. The power control circuit includes a processing unit and a control unit.

When the processing unit is connected to the solar power supply, the processing unit outputs a first control signal. The control unit is connected to the processing unit, the first battery, and the second battery, respectively. The control unit receives the first control signal to control the first battery and the second battery to alternately supply the power to the electronic device and to control the first battery and the second battery to be alternately charged by the solar power supply.

To sum up, when the power control circuit is connected to the solar power supply, the power control circuit in the invention can control the first battery and the second battery in the battery module to alternately supply the power to the electronic device and can control the first battery and the second battery to be alternately charged by the solar power supply. Therefore, the power energy converted from the solar energy can be efficiently used to prolong using time of the electronic device.

These and other features, aspects, and advantages of the present invention will become better understood with regard to the following description, appended claims, and accompanying drawings.

### BRIEF DESCRIPTION OF THE DRAWINGS

FIG. 1A is a functional block diagram showing a power control circuit connected to a solar power supply according to one embodiment of the invention.

FIG. 1B is a functional block diagram showing a power control circuit connected to an AC-DC adapter according to one embodiment of the invention.

FIG. 1C is a functional block diagram showing a power control circuit according to one embodiment of the invention.

FIG. 2 is a functional block diagram showing a power control circuit according to one embodiment of the invention.

FIG. 3 is a functional block diagram showing a battery module according to one embodiment of the invention.

FIG. 4 is a functional block diagram showing an electronic device according to one embodiment of the invention.

### DETAILED DESCRIPTION OF THE INVENTION

This invention provides a power control circuit and a battery module including the same. A plurality of embodiments about the power control circuit and the battery module in the invention are described hereinbelow.

An electronic device in the invention can refer to any device needing power for operation and, more particularly, to a data processing device such as a computer. In addition, the data processing device particularly refers to a portable data processing device such as a notebook computer, a tablet computer, an image capturing device, a multimedia player, a mobile communication device, or a personal digital assistant. However, the invention is not limited thereto.

In one embodiment, the power control circuit can control charge and discharge of the battery module. In an actual application, the battery module can be connected to the electronic device, and the battery module includes a first battery and a second battery. Further, the power control circuit can be selectively connected to different power supplies and can adjust power configuration modes according to different power sources. A solar power supply and an AC-DC adapter as the power supplies are taken for example, and an application mode of the power control circuit according to one preferred embodiment of the invention is described hereinbelow.

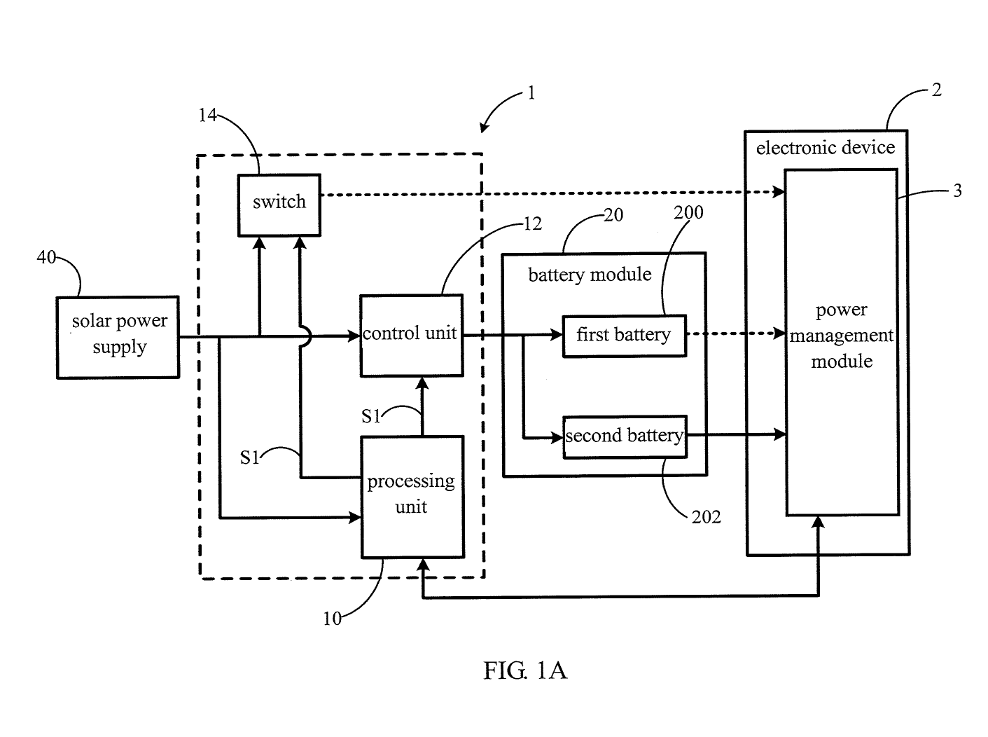

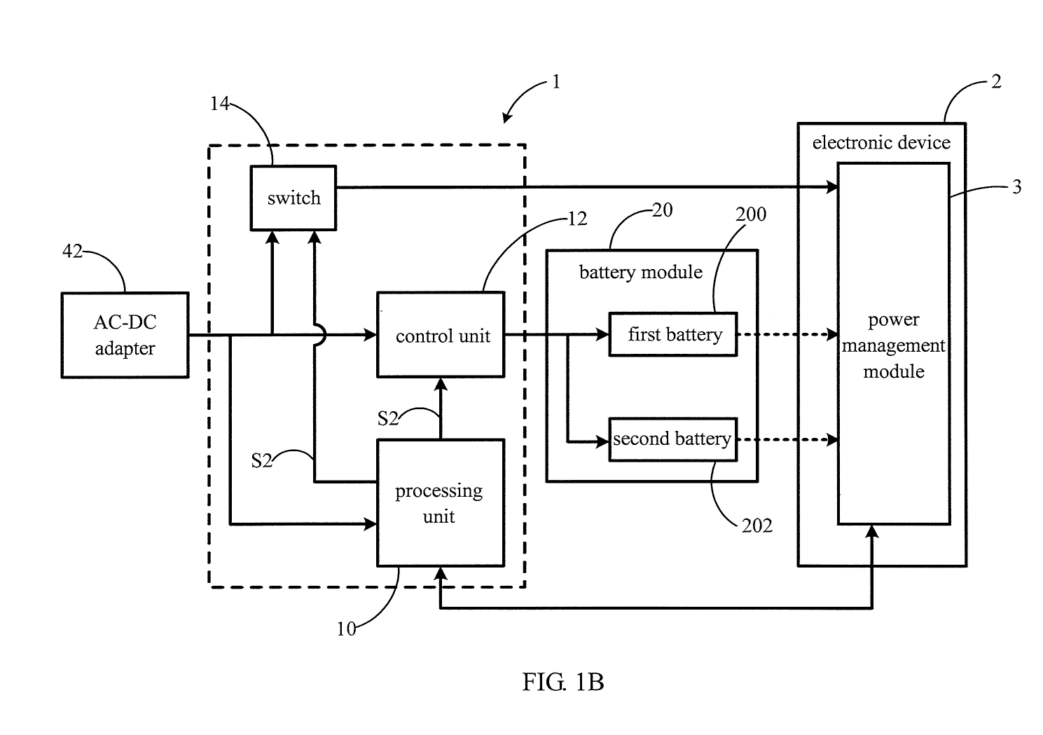

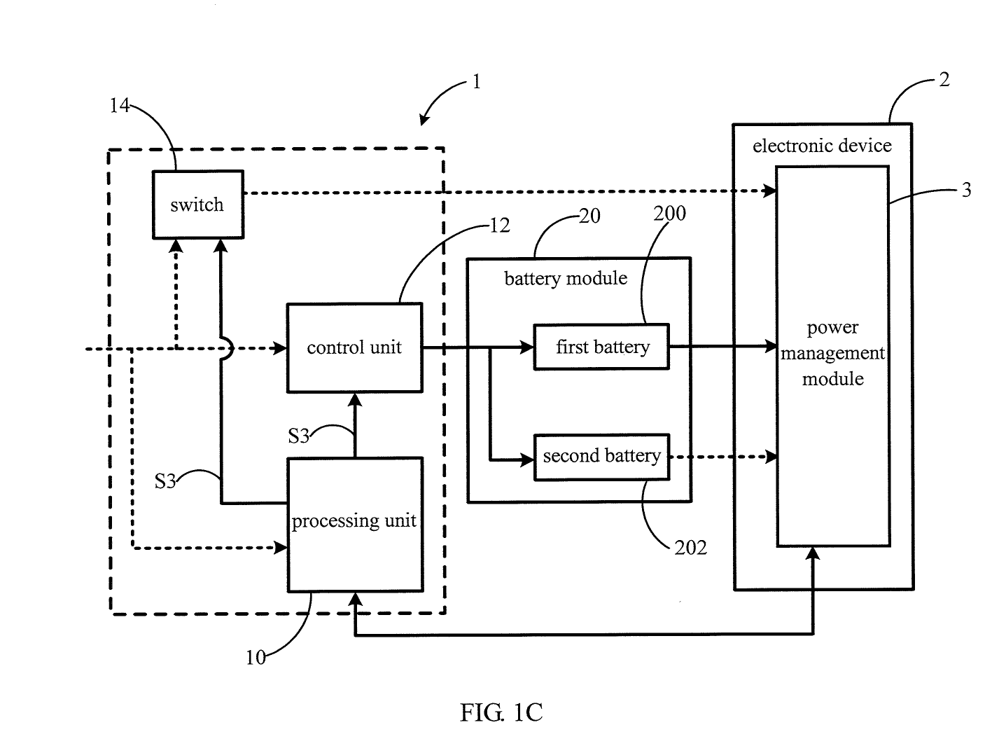

Please refer to FIG. 1A to FIG. 1C. FIG. 1A is a functional block diagram showing a power control circuit 1 connected to a solar power supply 40 according to one preferred embodiment of the invention. FIG. 1B is a functional block diagram showing a power control circuit 1 connected to an AC-DC adapter 42 according to one preferred embodiment of the invention. FIG. 1C is a functional block diagram showing a power control circuit 1 free from connecting any power supply according to one preferred embodiment of the invention.

According to the embodiment, the power control circuit 1 includes a processing unit 10, a control unit 12, and a switch 14. Further, the power control circuit 1 can control charge and discharge of a battery module 20. The battery module 20 is connected to an electronic device 2, and the battery module 20 includes a first battery 200 and a second battery 202. The electronic device 2 includes a power management module 3. The power management module 3 can be connected to the first battery 200, the second battery 202, and the switch 14 in a plugging mode or a soldering mode thus to receive power supplied by the first battery 200, the second battery 202, or the power supply (that is, the solar power supply 40 or the AC-DC adapter 42). In other embodiments, the power control circuit 1 may be disposed in the electronic device 2 for connecting the solar power supply 40. In addition, the electronic device 2 may further include the first battery 200 and the second battery 202. However, the invention is not limited thereto.

In FIG. 1A, when the processing unit 10 determines that the connected power supply is the solar power supply 40, that is, when the processing unit 10 is connected to the solar power supply 40 and determines that the connected device is the solar power supply 40, the processing unit 10 outputs a first control signal S1.

The control unit 12 is connected to the solar power supply 40, the processing unit 10, and the battery module 20, respectively. The control unit 12 receives the first control signal S1 from the processing unit 10. According to the first control signal S1, the control unit 12 controls the first battery 200 and the second battery 202 to alternately supply power to the power management module 3 in the electronic device 2. Then, the power management module 3 distributes the power to each electronic component in the electronic device 2. The control unit 12 controls the first battery 200 and the second battery 202 to be alternately charged by the solar power supply 40.

That is, when the control unit 12 controls the first battery 200 to be charged by the solar power supply 40, the control unit 12 controls the second battery 202 to supply the power to the electronic device 2; when the control unit 12 controls the second battery 202 to be charged by the solar power supply 40, the control unit 12 controls the first battery 200 to supply the power to the electronic device 2. In other words, when the power control circuit 1 according to the preferred embodiment of the invention is connected to the solar power supply 40, the control unit 12 controls the batteries 200, 202 in the battery module 20 respectively to be charged and discharge.

The switch 14 is connected to the solar power supply 40, the electronic device 2, and the processing unit 10, respectively. The switch 14 receives the first control signal S1 and is turned off according to the first control signal S1, such that the solar power supply 40 fails to supply power to the electronic device 2 via the switch 14. In other words, the solar power supply 40 only charges the battery module 20, and then the first battery 200 or the second battery 202 in the battery module 20 supplies the power to the electronic device 2. The solar power supply 40 does not directly supply the power to the electronic device 2.

In FIG. 1B, when the processing unit 10 determines that the connected power supply is the AC-DC adapter 42, the processing unit 10 outputs a second control signal S2. At that moment, the control unit 12 receives the second control signal S2 and controls to the first battery 200 and the second battery 202 to be charged by the AC-DC adapter 42 according to the second control signal S2. In addition, the switch 14 receives the second control signal S2 and is turned on according to the second control signal S2, such that the AC-DC adapter 42 can directly supply power to the power management module 3 of the electronic device 2 via the switch 14. Then, the power management module 3 distributes the power to each electronic component in the electronic device 2.

In other words, when the power control circuit 1 in the preferred embodiment of the invention is connected to the AC-DC adapter 42, the power control circuit 1 controls the AC-DC adapter 42 to directly supply the power to the electronic device 2 and controls the first battery 200 and the second battery 202 to be charged by the AC-DC adapter 42 in the battery module 20. In addition, the power control circuit 1 can also control the first battery 200 and the second battery 202 not to supply the power to the electronic device 2.

In FIG. 1C, when the power control circuit 1 in the embodiment is not connected to any power supply, the processing unit 10 outputs a third control signal S3, and the control unit 12 controls the first battery 200 and the second battery 202 to supply the power to the electronic device 2 according to the third control signal S3. In an actual application, the first battery 200 and the second battery 202 may simultaneously or alternately supply the power to the power management module 3 of the electronic device 2, and then the power management module 3 may distribute the power to each electronic component in the electronic device 2.

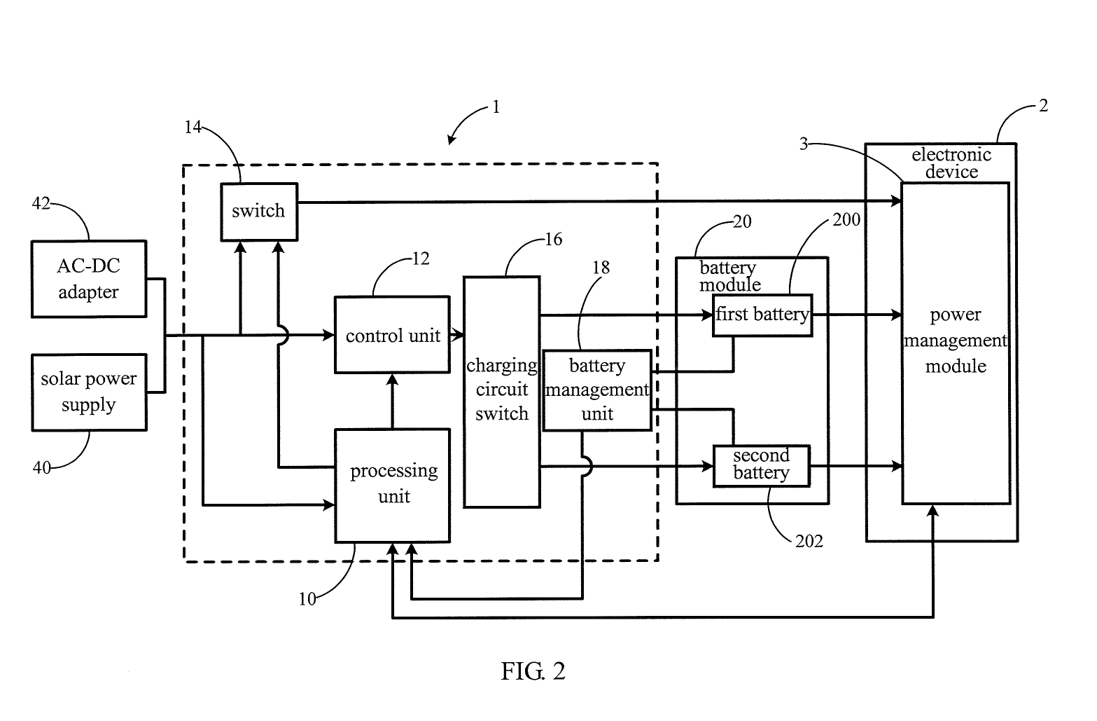

Please refer to FIG. 2. FIG. 2 is a functional block diagram showing a power control circuit 1 according to another embodiment of the invention. In FIG. 2, besides the aforementioned processing unit 10, the control unit 12, and the switch 14, the power control circuit 1 in the embodiment further includes a charging circuit switch 16 and a battery management unit 18.

The charging circuit switch 16 is connected to the control unit 12, a first battery 200, and a second battery 202, respectively, thus to switch connection states between a power supply (a solar power supply 40 or an AC-DC adapter 42) and the first battery 200 and the second battery 202.

For example, when the power control circuit 1 in the embodiment is in the state shown in FIG. 1A, the charging circuit switch 16 allows the circuit between the control unit 12 and the first battery 200 to be turned on and the circuit between the control unit 12 and the second battery 202 to be turned off. Thus, the solar power supply 40 can charge the first battery 200 instead of the second battery 202 via the control unit 12 and the charging circuit switch 16.

Further for example, when the power control circuit 1 in the embodiment is in the state shown in FIG. 1B, the charging circuit switch 16 simultaneously allows the circuits between the control unit 12 and the first battery 200 and between the control unit 12 and the second battery 202 to be turned on. Thus, the first battery 200 and the second battery 202 can be simultaneously charged by the AC-DC adapter 42 via the control unit 12 and the charging circuit switch 16. Certainly, in an actual application, operation of the charging circuit switch 16 may be adjusted according to other mechanisms. The invention is not limited to thereto.

In addition, the battery management unit 18 is connected to the processing unit 10, the first battery 200, and the second battery 202. The battery management unit 18 can regularly detect states of the first battery 200 and the second battery 202 to obtain a state value, such as remaining capacity, a temperature, a discharge voltage, a discharge current and so on. However, the invention is not limited thereto. Further, the battery management unit 18 can feed back the state value to the processing unit 10.

According to the state value, the processing unit 10 outputs a proper instruction signal at any time thus to drive the control unit 12 to control charge and discharge of the first battery 200 and the second battery 202. For example, when the processing unit 10 is connected to the solar power supply 40 and the battery management unit 18 detects that the state value of the second battery 202 is abnormal, the processing unit 10 may output a switch signal according to the abnormal state value, and according to the switch signal, the control unit 12 may control the second battery 202 to stop supplying power to the electronic device 2 and control the first battery 200 to supply power to the electronic device 2.

The power control circuit 1 in the embodiment may be integrated into a single circuit board and may be disposed in a proper device or module such as the aforementioned electronic device 2 or the battery module 20; according to different conditions, the power control circuit 1 may also be separately disposed in different devices or modules. For example, the control unit 12, the charging circuit switch 16, and the battery management unit 18 may be disposed in the battery module 20, and the processing unit 10 and the switch 14 may be disposed in the electronic device 2.

In an actual application, the processing unit 10, the control unit 12, and the switch 14 may be components having proper functions according to different conditions. For example, the processing unit 10 may be a micro processor; the switch 14 may be a field effect transistor (FET). However, the invention is not limited thereto.

The invention further provides a battery module including the aforementioned power control circuit for supplying power to an electronic device.

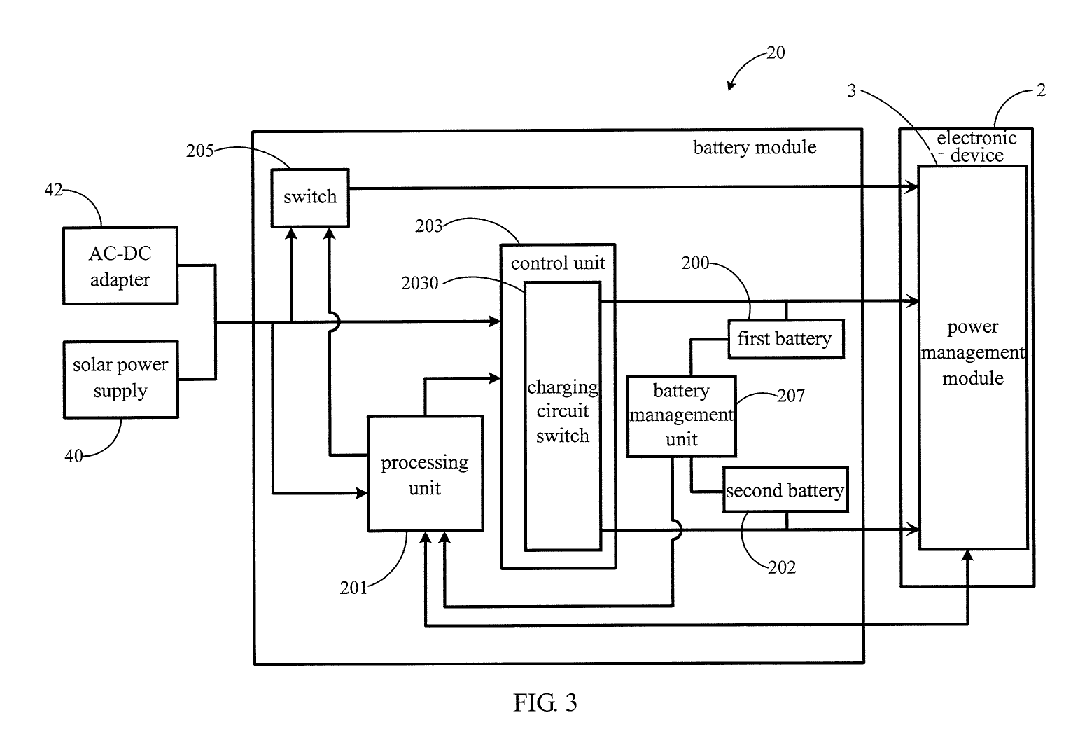

Please refer to FIG. 3. FIG. 3 is a functional block diagram showing a battery module 20 according to one embodiment of the invention. In FIG. 3, the battery module 20 in the embodiment includes a first battery 200, a second battery 202, a processing unit 201, a control unit 203, a switch 205, and a battery management unit 207.

As described above, the processing unit 201 can be connected to a solar power supply 40 or an AC-DC adapter 42. In some case, the processing unit 201 may be not connected to any power supply. The control unit 203 can be connected to the solar power supply 40 or the AC-DC adapter 42, or the control unit 203 is not connected to any power supply. Further, the control unit 203 is connected to the processing unit 201. In addition, as shown in FIG. 3, the control unit 203 further includes a charging circuit switch 2030 connected to the first battery 200 and the second battery 202, respectively.

The switch 205 can be connected to the solar power supply 40 or the AC-DC adapter 42, or the switch 205 is not connected to any power supply. Further, the switch 205 is connected to the processing unit 201. In addition, the battery management unit 207 is connected to the processing unit 201, the first battery 200, and the second battery 202.

When the power supply is the solar power supply 40, the processing unit 201 outputs a first control signal. According to the first control signal, the control unit 203 controls the charging circuit switch 2030 to turn on such that power from the solar power supply 40 can be supplied to the first battery 200, thereby the first battery 200 being charged. At the same time, according to the first control signal, the control unit 203 controls the second battery 202 to supply power to the power management module 3 of the electronic device 2, and then the power management module 3 distributes the power to each electronic component in the electronic device 2. In addition, the switch 205 is turned off according to the first control signal, such that the solar power supply 40 fails to supply the power to the power management module 3 of the electronic device 2 via the switch 205.

In addition, when the power supply is the AC-DC adapter 42, the processing unit 201 outputs a second control signal. According to the second control signal, the control unit 203 controls the charging circuit switch 2030 to turn on, such that power from the AC-DC adapter 42 can be supplied to the first battery 200 and the second battery 202 to charge the first battery 200 and the second battery 202. Further, the switch 205 is turned on according to the second control signal, such that the AC-DC adapter 42 can supply the power to the power management module 3 of the electronic device 2 via the switch 205, and then the power management module 3 distributes the power to each electronic component in the electronic device 2.

When the processing unit 201 is not connected to any power supply, the processing unit 201 outputs a third control signal. According to the third control signal, the control unit 203 controls the first battery 200 and the second battery 202 to supply the power to the power management module 3 of the electronic device 2, and then the power management module 3 distributes the power to each electronic component in the electronic device 2.

As described above, the battery management unit 207 can regularly detect states of the first battery 200 and the second battery 202 and feeds back a state value to the processing unit 201. According to the state value, the processing unit 201 outputs a proper instruction signal at any time thus to drive the control unit 203 and the charging circuit switch 2030 to control charge and discharge of the first battery 200 and the second battery 202.

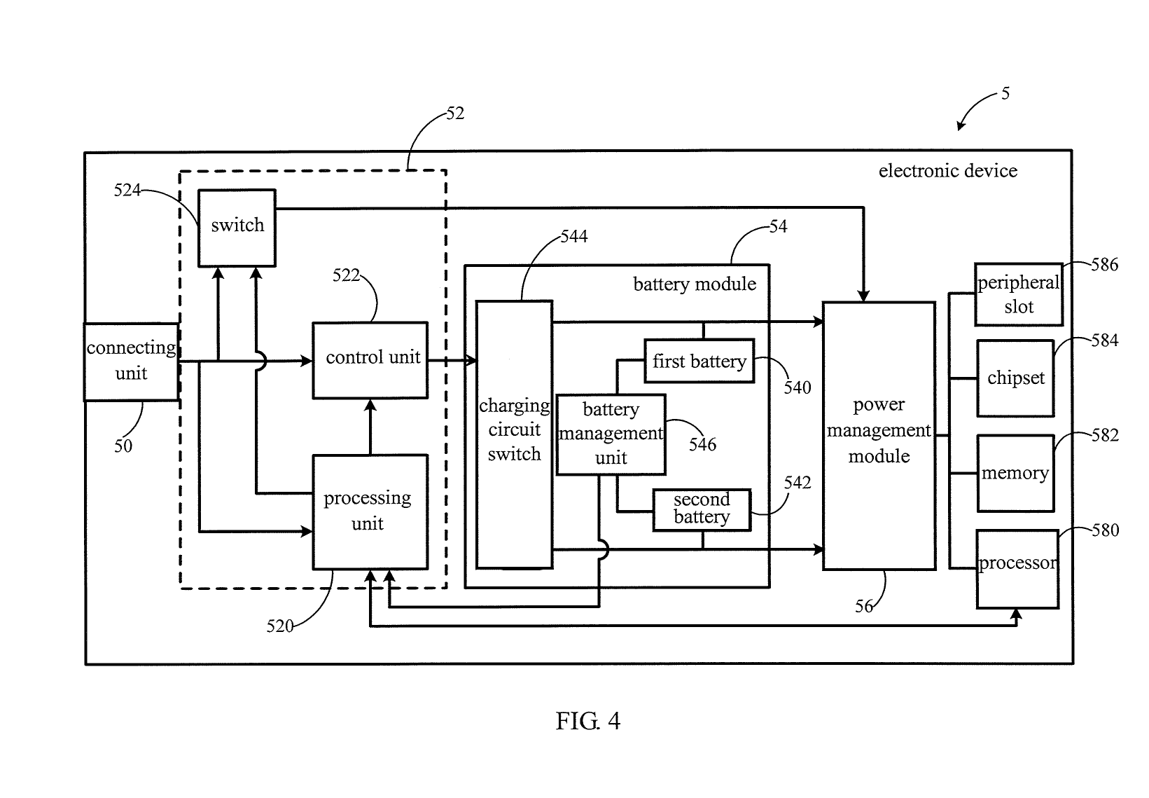

In one embodiment, a power control circuit in the embodiment can be disposed in an electronic device. Please refer to FIG. 4, FIG. 4 is a functional block diagram showing an electronic device 5 according to one embodiment of the invention. In FIG. 4, the electronic device 5 in the embodiment includes a connecting unit 50, a power control circuit 52, a battery module 54, a power management module 56, and a plurality of electronic components including units or modules, such as a processor 580, a memory 582, a chipset 584, a peripheral device slot 586 and so on, needed in operation of the electronic device 5.

The connecting unit 50, such as a plugging hole, can allow different kinds of power supplies as mentioned above to be connected by a user. The power control circuit 52 includes a processing unit 520, a control unit 522, and a switch 524. Further, the processing unit 520, the control unit 522, and the switch 524 are connected to the connecting unit 50, respectively. In addition, the battery module 54 includes a first battery 540, a second battery 542, a charging circuit switch 544, and a battery management unit 546.

The power management module 56 can be connected to the first battery 540, the second battery 542, and the switch 524 in a plugging mode or a soldering mode thus to receive power supplied by the first battery 540, the second battery 542, or the power supply. In addition, the operating units or functional modules, such as the processor 580, the memory 582, the chipset 584, the peripheral device slot 586 and so on, are connected to the power management module 56, respectively, thus to receive the power needed by operation from the power management module 56.

In the embodiment, connections and functions of each unit included in the power control circuit 52 and the battery module 54 are the same as that described above. Therefore, they are not described herein for a concise purpose.

To sum up, according to the preferred embodiments of the invention, the power control circuit can adjust power configuration modes according to different power sources. Particularly, when the power source is the solar power supply, the power control circuit in the preferred embodiments of the invention can control the first battery and the second battery in the battery module to alternately supply the power to the electronic device and control the first battery and the second battery to be alternately charged by the solar power supply. Further, the power control circuit in the preferred embodiments of the invention can switch between charge and discharge according to the state of each battery unit thus to prolong using time of the electronic device by efficiently using power energy converted from solar energy.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A power control circuit provided in an electronic device and connected to a solar power supply, the electronic device including a first battery and a second battery, the power control circuit comprising:
a processing unit for outputting a first control signal when the processing unit is connected to the solar power supply; and
a control unit connected to the processing unit, the first battery, and the second battery, respectively,
wherein the control unit receives the first control signal to control the first battery and the second battery to alternately supply power to the electronic device and to control the first battery and the second battery to be alternately charged by the solar power supply.

2. The power control circuit according to claim 1, further comprising:
a switch connected to the solar power supply, the electronic device, and the processing unit, respectively, the switch receiving the first control signal and being turned off according to the first control signal, such that the solar power supply fails to supply power to the electronic device via the switch.

3. The power control circuit according to claim 1, wherein when the processing unit is connected to an AC-DC adapter, the processing unit outputs a second control signal, and the control unit controls the first battery and the second battery to be charged by the AC-DC adapter according to the second control signal.

4. The power control circuit according to claim 3, further comprising:
a switch connected to the AC-DC adapter, the electronic device, and the processing unit, respectively, the switch receiving the second control signal and being turned on according to the second control signal, such that the AC-DC adapter supplies power to the electronic device via the switch.

5. The power control circuit according to claim 1, wherein when the first battery is charged by the solar power supply, the second battery supplies the power to the electronic device, and when the second battery is charged by the solar power supply, the first battery supplies the power to the electronic device.

6. The power control circuit according to claim 1, further comprising:
a battery management unit connected to the processing unit, the first battery, and the second battery for detecting a state value related to the first battery and the second battery and feeding back the state value to the processing unit.

7. The power control circuit according to claim 6, wherein when the second battery supplies the power to the electronic device and the state value of the second battery is abnormal, the processing unit outputs a switch signal, and according to the switch signal, the control unit controls the second battery to stop supplying the power to the electronic device and controls the first battery to supply the power to the electronic device.

8. The power control circuit according to claim 6, wherein the state value is selected from the group consisting of remaining capacity, a temperature, a discharge voltage, and a discharge current.

9. A battery module for supplying power to an electronic device, the battery module comprising:
a first battery;
a second battery; and
a power control circuit connected to a solar power supply for controlling operation of the first battery and the second battery, the power control circuit including:
a processing unit, outputting a first control signal when the processing unit is connected to the solar power supply; and
a control unit connected to the processing unit, the first battery, and the second battery, respectively,
wherein the control unit receives the first control signal to control the first battery and the second battery to alternately supply the power to the electronic device and to control the first battery and the second battery to be alternately charged by the solar power supply.

10. The battery module according to claim 9, further comprising:
a switch connected to the solar power supply device, the electronic device, and the processing unit, respectively, the switch receiving the first control signal and being turned off according to the first control signal, such that the solar power supply fails to supply power to the electronic device via the switch.

11. The battery module according to claim 9, wherein when the processing unit is connected to an AC-DC adapter, the processing unit outputs a second control signal, and the control unit controls the first battery and the second battery to be charged by the AC-DC adapter according to the second control signal.

12. The battery module according to claim 11, further comprising:
a switch connected to the AC-DC adapter, the electronic device, and the processing unit, respectively, the switch receiving the second control signal and being turned on according to the second control signal, such that the AC-DC adapter supplies power to the electronic device via the switch.

13. The battery module according to claim 9, wherein when the first battery is charged by the solar power supply, the second battery supplies the power to the electronic device, and when the second battery is charged by the solar power supply, the first battery supplies the power to the electronic device.

14. The battery module according to claim 9, further comprising:
a battery management unit connected to the processing unit, the first battery, and the second battery for detecting a state value related to the first battery and the second battery and feeding back the state value to the processing unit.

15. The battery module according to claim 14, wherein when the second battery supplies the power to the electronic device and the state value of the second battery is abnormal, the processing unit outputs a switch signal, and according to the switch signal, the control unit controls the second battery to stop supplying the power to the electronic device and controls the first battery to supply the power to the electronic device.

16. The battery module according to claim 14, wherein the state value is selected from the group consisting of remaining capacity, a temperature, a discharge voltage, and a discharge current.
